(19) United States
(12) Patent Application Publication
(10) Pub. No.: US 2007/0201677 A1
(43) Pub. Date: Aug. 30, 2007

(54) Enhanced directory assistance system with enhanced peripheral call queuing and handling

(76) Inventors: Michael Bates, Bethlehem, PA (US); Harry Lamarque, Easton, PA (US); Faith McGary, Bethlehem, PA (US)

Correspondence Address: SOFER & HAROUN LLP., 317 MADISON AVENUE, SUITE 910, NEW YORK, NY, 10017, US

(21) Appl. No.: 11/653,186

(22) Filed: Jan. 11, 2007

Related U.S. Application Data
(60) Provisional application No. 60/758,250, filed on Jan. 11, 2006.

(51) Int. Cl. H04M 3/00; H04M 5/00

(52) U.S. Cl. 379/265.01

(57) ABSTRACT

A directory assistance system includes a plurality of call centers, each configured to handle a directory assistance request from a caller. An ICM/IVR edge queuing module has a first IVR module and second ICM module and is coupled to each of the call centers. The ICM/IVR edge queuing module receives an incoming call from a caller and obtains interactive responses pertinent to call center routing. The ICM module routes the call to one call center among the plurality of call centers based on a type of service requested by the caller as determined by the interactive responses received by the IVR module.

### RELATED APPLICATION

This application is related to and claims the benefit of priority from U.S. Provisional Patent Application No. 60/758,250, filed on Jan. 11, 2006, the entirety of which is incorporated herein by reference.

### FIELD OF THE INVENTION

This application is related to a directory assistance platform. More particularly, the present invention is directed to an enhanced directory assistance platform with enhanced queuing and call direction.

### BACKGROUND

In traditional directory assistance platforms incoming calls are typically received at an ICM (Call Management) module which in turn routes the call to an ACD (Automatic Call Distribution) module, located at a particular call center within the DA platform. The call is then distributed to an available operator or automated platform to handle the call.

In the current state of the art, once the call is received at the call center, input is received from the caller by IVR (Interactive Voice Response) in order to route the call to the appropriate operator (ie. Spanish language etc . . . ). This IVR is handled once the call is beyond the ICM and already within the call centers.

However, due to the expansion of call volume and services offered, a directory assistance platform may employ a number of linked call centers, each of which are located geographically remote from one another. These call centers may maintain operator terminals that are principally dedicated to their geographic locations or to a particular service (ie. directions, reservations, special language etc . . . ).

For example, FIG. 1 illustrates a prior art arrangement whereby a directory assistance platform 10 maintains an ICM module 11 for routing calls to three geographically remote call centers 12a-12c, each of which employs an incoming call receiving module 14a-14c, an ACD module 16a-16c and a series of customer service agent modules 18a-18c. Due to customer preferences and demographics, it is assumed that although customer service agents 18a-18c can address all directory assistance that customer needs, some service agent modules 18 of call centers 12 may specialize in certain services. For example, service agent 18a may have more operators for Spanish language, service agent module 18b may have more operators trained for providing directions and service agent module 18c may have more operators for providing standard telephone directory assistance.

In such a prior art system, an exemplary caller 20 who dials into the directory assistance platform 10 from a geographic location near call center 18c would initially be directed by ICM 11 to the corresponding incoming call receiving module 14c and/or ACD 16c where they would be prompted with IVR questions regarding their call handling preferences (ie. Spanish, directions, standard DA, etc . . . ). If caller 20 requests Spanish language, it may be the case that the next available operator to handle a Spanish language call is at service agent module 18a which, as noted above, maintains more Spanish language operators. In such an instance, ACD 16c would need to redirect the call within directory assistance platform 10 over to ACD 16a for distribution to the appropriate operator at service platform 18a. It is noted that in addition to a repeat request for special services and its associated operation activity within the system, such re-routing may result in other factors such as call volume overflow.

By this illustration, it can be seen how such a process, where IVR is handled within call centers 12, creates additional call traffic, where an incoming call must first enter a call center 12 among the call centers of directory assistance platform 10, before being re-routed to a different call center 12, better equipped to handle the call and its corresponding required service. Such call re-routing causes delays and the concomitant customer dissatisfaction, while simultaneously acting as a drain on platform resources.

### OBJECTS AND SUMMARY

The present invention looks to overcome the drawbacks associated with the prior art by incorporating an edge queuing module into a directory assistance platform. As such, the calls, before being directed to a particular call center, may be addressed by a preliminary edge network module so that the call may be routed in advance to the most appropriate call center within the directory assistance platform. Furthermore, interactions between the user and edge network module, necessary for properly directing the call, may be further utilized to enhance a user's directory assistance experience by expediting certain directory assistance request procedures.

To this end, the present invention provides for a directory assistance system includes a plurality of call centers, each configured to handle a directory assistance request from a caller. An ICM/IVR edge queuing module has a first IVR module and second ICM module and is coupled to each of the call centers. The ICM/IVR edge queuing module receives an incoming call from a caller and obtains interactive responses pertinent to call center routing. The ICM module routes the call to one call center among the plurality of call centers based on a type of service requested by the caller as determined by the interactive responses received by the IVR module.

### BRIEF DESCRIPTION OF THE DRAWINGS

The present invention can be best understood through the following description and accompanying drawings, wherein:

FIG. 1 is a prior art directory assistance system;

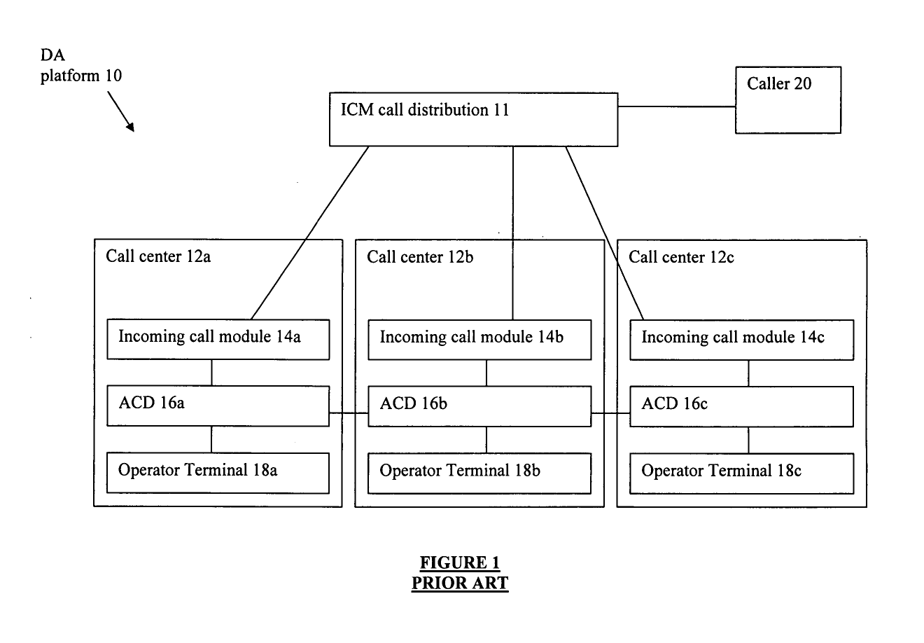

FIG. 2 illustrates a directory assistance platform with and edge network element, within one embodiment of the present invention;

FIG. 3 is a table used by the ICM/IVR module of the directory assistance platform of FIG. 2; in accordance with one embodiment of the present invention; and

FIG. 4 is a flow chart illustrating the operation of directory assistance platform of FIG. 2, within one embodiment of the present invention.

### DETAILED DESCRIPTION

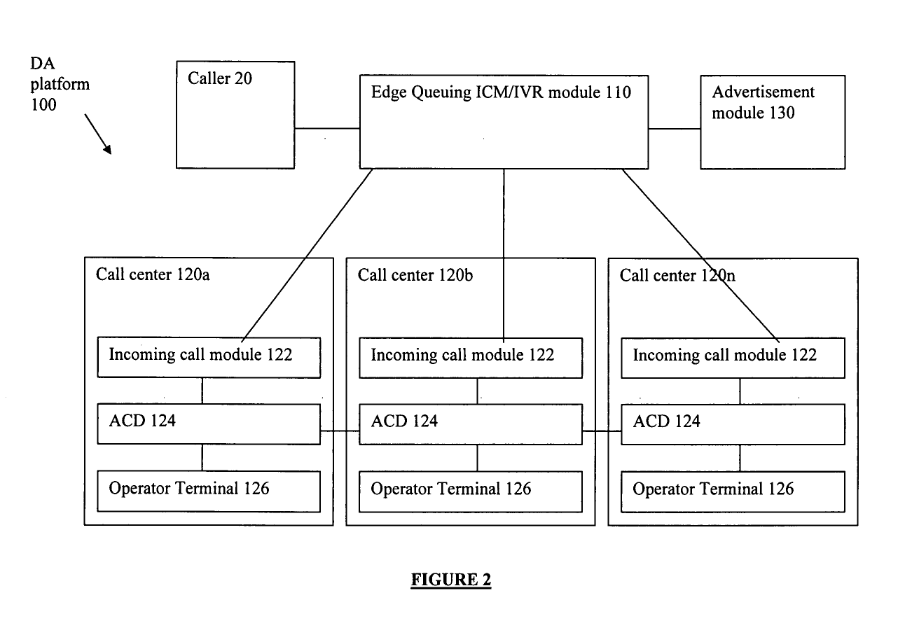

In one embodiment of the present invention, as illustrated in FIG. 2, a directory assistance platform 100 is depicted having an edge queuing ICM/IVR module 110 (Call Management/Interactive Voice Response) located at the periphery of a network of geographically remote call centers 120a-120n, each of which maintains an incoming call receiving module 122, an ACD module 124 and a plurality of operator terminals 126.

It is understood that the above modules of directory assistance platform 100 are for exemplary purposes in illustrating the salient features of the present invention and are no way intended to limit the scope of the present invention. As such, certain modules may be added or removed from platform 100 while still maintaining the principle features of the invention.

Edge queuing ICM/IVR module 110 may employ commercially available ICM call management hardware and software. Additionally, ICM/IVR module 110 includes an interactive Voice Response function that is configured to request/collect information, either by touch tone response or other any other electronic means, from caller 20 that is then used to assist in routing the call to the appropriate call center 120 as discussed in more detail below.

It is understood that ICM/IVR edge queuing module 110 is shown in FIG. 2 as a single module coupled to call centers 120. However, it is understood that DA platform 100 may employ numerous edge queuing modules 110 in a distributed manner throughout the platform, each managing one or more call centers 120. Furthermore, ICM/IVR edge queuing module 110 is shown as a single module, but it is understood that the ICM functionality may be employed in a first set of hardware/software and that the IVR functionality may be employed in a second set of connected hardware software. The two functionalities are shown as combined in ICM/IVR edge queuing module 110 for the purposes of illustrating their coupled role within the context of the present invention. However, it is contemplated that functionalities may be separated into separate computer hardware/software arrangements as necessary, provided they operate consistently with their below described coupled abilities.

Call centers 120a, 120b, 120c . . . employ typical call handling communication equipment used in directory assistance platforms. For example, incoming call handling modules 122 may employ standard telephony switches for handling calls from the PSTN (Public Switched Telephone Network) as well servers for handling incoming soft calls from VoIP phones and other internet routed incoming communications. Likewise, ACD 124 may be any typical Automatic call distribution and call queuing hardware/software for handling both traditional and soft telephone calls. Operator terminals 126 may include live operators as well as automated response equipment or a combination of the two.

Although it is assumed that each of call centers 120 are capable of handling any incoming directory assistance requests from caller 20, call centers 120 are considered to be both geographically remote from one another and to maintain operator terminal balances that reflect the market in which they are located.

For example, a first call center 120 located in a market with a large Spanish speaking population may employ an increased number of Spanish language operators 126. Likewise, a second call center 120 located in an area where directions requests are frequently made may employ an increased number of operators 126 trained in providing directions.

It is understood that that the exact balance of service operator terminals 126, and the services they handle is immaterial, as the number of potential services (traditional directory assistance, Spanish language, directions, traffic requests, restaurant reservations/reviews, movie times/tickets, etc . . . ) are too numerous to list in total. For the purpose of illustrating the salient features of the present invention it is simply understood that each of the geographically remote call centers 120 maintain a number of operator terminals 126, which are balanced to support a range of services according to some criteria, such as the geographic market they are located in or the available skills of operators in the region, and that such balance may be different from one remote call center 120 to the next.

In one embodiment of the present invention, referring again to FIG. 2, an advertisement module 130 may be included in directory assistance platform 100. Advertisement module may be used to play an audio message, send a text (SMS, HTML etc . . . ) message or any other form of commercial communication to caller 20. As noted below, the advertisement may be either a generic advertisement played at the beginning of the call or it may be sent at the end of the session with ICM/IVR edge module 110. Ideally, if the message is sent at the end, after the below described IVR exchange, the advertisement may be tailored to the responses provided by caller 20. For example, a Spanish language IVR request may result in the advertisement played to the caller in Spanish. Likewise, a directions request and subsequent routing to a directions capable call center 120 may include an advertisement from module 130 for travel related commercial establishments (hotels, etc . . . ). By targeting advertisement in such ways, increased revenue streams may be derived from the advertisers, potentially for use in providing an advertiser paid call to platform 100. It is understood that the present invention contemplates that any related advertising delivery or billing schema used in directory assistance systems may be utilized with advertisement module 130 in furtherance of the below described features.

Turning now to call operations, when caller 20 initially contacts directory assistance platform using a national number, such as 1-800-xxx-xxxx, or via their carrier using 411 or some other directory assistance exchange, this call is initially handled by edge queuing ICM/IVR module 110.

Unlike prior art systems, ICM/IVR module 110, instead of simply routing the call using standard ICM technologies (load balancing, etc . . . ), issues requests to caller 20 for information pertinent to the routing of the call after queuing module 110 is notified of the type of service desired by caller 20 in response to the IVR interaction. For example, ICM/IVR module 110 may initiate a sequence of interactive questions. An exemplary exchange may include:

“For English press 1 or remain on the line”

“For Spanish press 2”

“For ______ language press 3” etc . . .

Upon receiving a user response for Spanish language for example, ICM/IVR module 110 may route the call into a call center 120 that has a particularly high ratio of Spanish language operators 126 to ensure the best possible call response time for caller 20. It is noted that ICM/IVR queuing module 110 still performs load balancing functions based on available operator terminals 126 at call centers 120, however, in view of the present invention, it is additionally tailored to services/language selected by caller 20 at IVR.

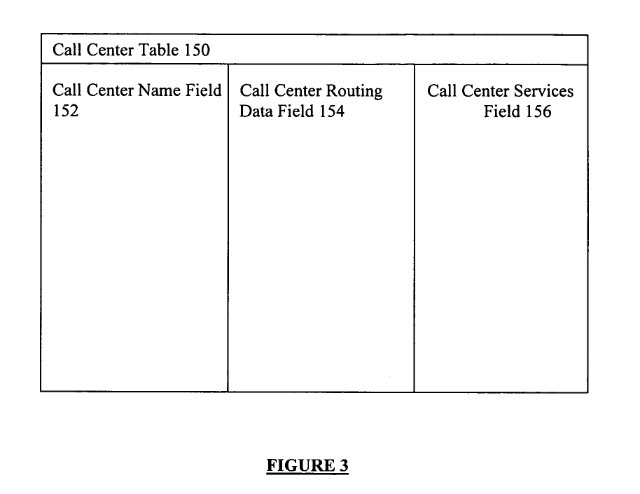

If English is selected, ICM/IVR module 110 may default routing of the call to either the closest geographically located call center 120 or to another call center 120 based on standard directory assistance platform wide load balancing. Obviously, in the alternative arrangement from FIG. 3, the IVR data is collected by IVR modules 121 and then forwarded back to edge queuing module 110′ for proper call routing.

In another embodiment of the present invention, as noted above, directory assistance platform 100 also offers additional services beyond the language. Thus, ICM/IVR module 110 may ask a different set of IVR questions to caller 20. An exemplary exchange may include:

“For directory assistance press 1”

“For directions press 2”

“For movie information press 3”

“For restaurant information press 4” etc . . .

It is noted that these questions may be issued to caller 20 either alone or in addition to the previously discussed language questions. Obviously, if more than one IVR question is presented to user 20, ICM/IVR module 110 selects the appropriate call center 120 to route the call to, based on all collected information. For example, if a user wants Spanish language and directions, a call center 120 is selected that is most likely to have an available Spanish language, directions trained operator 126 available. Such a system amounts to services based routing as opposed to simple load balancing routing used in prior art methods.

In another embodiment of the present invention, it is contemplated that with some repeat callers 20, directory assistance system 100 may maintain a profile of caller 20 that may already include certain language preferences. In such situations, when a caller contacts directory assistance platform 100, it is contemplated that edge queuing ICM/IVR module 110 has access to such profile and routes the call to an appropriate call center 120 accordingly the same as if it had collected such preference by IVR. Such profiles may even be managed directly by caller 20 through an internet connection or verbally/automated with a customer service agent at directory assistance platform 100.

In another embodiment of the present invention, as illustrated in FIG. 3, a call center table 150 is maintained by edge queuing ICM/IVR module 110 so that once the caller 20 responses are received, ICM/IVR module has the necessary information for routing the call. Call center table 150 may include exemplary fields of call center identifier field 152, call center routing data 154 containing the necessary routing data for routing a call to that call center 120, and call center services field 156 that contains the data regarding what services are supported by that call center 120 and in what capacity (eg. Spanish language (10% of operators), directions (20% operators) etc . . . ). It is understood that additional fields may be added as desired by directory assistance platform 100 administrator if desired.

In one embodiment of the present invention, call center services field is static and based solely on the known quantities of operators at operator terminals 126 for each call center 120. However, it is contemplated that edge queuing ICM/IVR module 110, as it is in constant communication with call centers 120, may contain dynamically changing data on each call center such that the exact or nearly exact current capacity for each service handled is known.

For example, a directory assistance platform 100 may maintain two call centers 120 that employ 10% Spanish language operators. If call center services field 156 includes static data then ICM/IVR module 110, when receiving a caller 20 request for Spanish language services, will simply route the call to either call center 120. However, with dynamic information in call center services field 156, if one of those two call centers 120 is experiencing very high call volume (and a corresponding decrease in available Spanish speaking operators 126) then edge queuing ICM/IVR module 110 selects to route the Spanish language requested call to the other call center 120, having more available Spanish language operators 126.

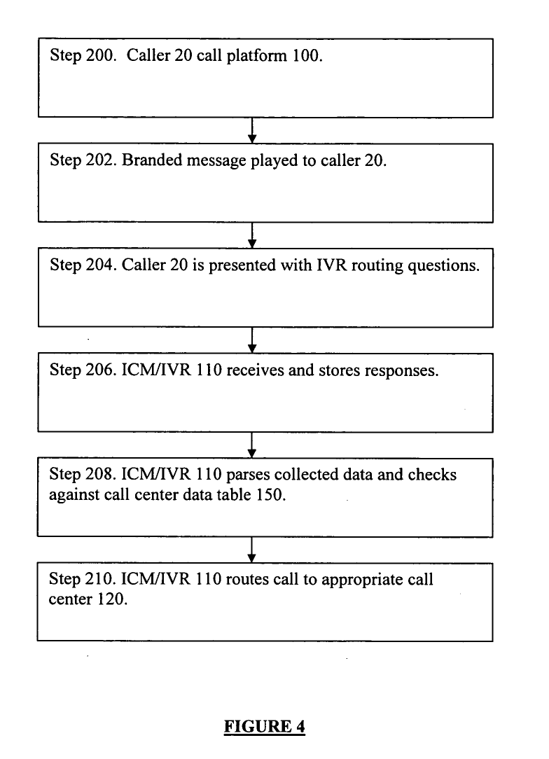

FIG. 4 illustrates an exemplary flow chart for a call flow through directory assistance platform 100 exhibiting the features of the present invention. In this example, user 20 is selecting Spanish language services, however, such flow chart is equally applicable to any selected services identified above.

At a first step 200, a user 20 calls platform 100, with the call being collected by edge queuing ICM/IVR module 110. Next, at step 202, an optional branding message or advertisement may be played to caller 20. This step may be alternatively placed after the routing steps such that the IVR communications may be utilized in better targeting the advertisements. For example, if a user indicates Spanish language preference, advertisement module 130 may play the desired advertisement to caller 20 in Spanish.

At step 204, ICM/IVR module 110 presents its IVR questions to user 20, such as, “Press 1 or hold for English” “Press 2 for Spanish.” At step 206, user 20 makes their response, and at step 208, edge queuing ICM/IVR module 110 parses the response and references call center table 150 to select an appropriate call center 120. Finally, at step 210, ICM/IVR module 120 routes the call to the operator queue of ACD 124 in the selected call center 120. Again, it is understood that additional steps may be added/subdivided or steps may be removed/combined, provided that the overall process includes the primary steps of holding a call at the edge of platform 100 and making a primary call routing decision prior to delivering the call to a call center 120.

In another embodiment of the present invention, it is contemplated that the IVR data collected by edge queuing ICM/IVR module 110 may be supplemented and/or enhanced so that additional functions may be carried out at the edge of directory assistance platform 100 before being handled by an ACD 124 of a call center 120, to avoid redundant or bifurcated IVR activity.

For example, in the case where calls to directory assistance platform 100 are being handled in an automated manner at operator terminals 126, caller 20 is typically prompted to state the city and state of the requested listing. In prior art systems, as with the other routing pertinent questions (ie. Spanish language, directions etc . . . ), this information is collected within the call center itself to be used by automated operators to assist in locating the listing. If not found, the call is transferred to a live operator and caller then re-requests the information.

In another such example, edge queuing ICM/IVR module 110 may include full automated DA capacity. For example, as noted above, directory assistance systems typically employ automated response systems instead of live customer service agents. The above examples note that ICM/IVR module 110 may collect, in addition to pure routing data, data from callers 20 necessary for making the directory assistance query itself. In the event that this information is able to be sufficiently collected at the edge of DA platform 100 by ICM/IVR edge module 110 and no live operator is needed it is contemplated that that the ICM/IVR edge module 110 may, even before ever routing the call into a call center 120 use a limited channel to request and upload the necessary listing information from call center 120 so that the call may be routed directly to the intended party before ever needing to be sent to a call center 120 at all.

A variation of this embodiment would forward such fully automated response information to a live customer service agent 126, possibly specialized for such purposes, to receive the IVR responses from caller 20, along with the automated response and intended call completion data, so as to assist in the routing/completion of the call. Such an arrangement may be utilized in the event of an error in the fully automated handling by ICM/IVR edge module 110 or in the case of an unusually complicated request.

According to the present invention, edge queuing ICM/IVR module 110 at the edge of the directory assistance platform 100, when requesting the routing pertinent questions discussed above, may also obtain standard directory assistance IVR information as well such as “city and state” information from caller 20, which it can in turn record. Then, when a listing cannot be found by the automated operator 126 and the call is forwarded to live operator 126 at the same call center 120 for further processing, the recorded “city and state” information can be forwarded and played to the operator 126 as a “whisper” (without caller 20 hearing it again), before picking up the call, so that caller 20 does not need to repeat the information a second time.

Such an action is an example of one such use of IVR information that is collected by edge queuing ICM/IVR module 110 that may be used by operator terminals 126. However, it is contemplated that any IVR information collected by edge queuing ICM/IVR module 110 may be pushed to call center 120 for use in a similar manner.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

1) A directory assistance system comprising:
a plurality of call centers, each configured to handle a directory assistance request from a caller; and
an ICM/IVR edge queuing module, having a first IVR module and second ICM module, coupled to each of said call centers configured to receive an incoming call from a caller, wherein said IVR module is configured to obtain interactive responses from a caller pertinent to call center routing, and wherein said ICM module routes said call to one call center among said plurality of call centers based on a type of service requested by said caller as determined by said interactive responses received by said IVR module.

2. The system as claimed in claim 1, wherein each of said call centers maintains a plurality of customer service agents, each capable of providing a desired service to said caller.

3. The system as claimed in claim 1, wherein said interactive responses at said IVR are related to language preferences of said caller.

4. The system as claimed in claim 1, wherein said interactive responses at said IVR are related to special services offered by said call centers.

5. The system as claimed in claim 1, wherein said ICM module maintains a table including information regarding the ability of customer service representatives at said call centers to handle special services.

6. The system as claimed in claim 5, wherein said table is dynamically updated based on real time status of said customer service representatives at said call centers.

7. The system as claimed in claim 1, further comprising an advertising module, coupled to said IVR module for providing advertisements to said caller prior to call routing to a particular call center.

8. The system as claimed in claim 7, wherein said advertisement is modified based on said interactive response provided to said IVR module by said caller.

9. The system as claimed in claim 1, wherein said IVR module is further configured to receive additional interactive responses from said caller relating to a directory assistance request, such that said IVR module may handle the directory assistance request in an automated fashion.

10. The system as claimed in claim 9, wherein said additional interactive responses from said caller relating to a directory assistance request are whispered to a customer service representative at said call center in order to assist in providing a requested listing to said caller.

11. A directory assistance system comprising:
a plurality of call centers, each configured to handle a directory assistance request from a caller;
an IVR module, coupled to said call centers configured to obtain interactive responses from a caller pertinent to call center routing, and
an ICM module, coupled to said call centers and said IVR module, configured to route said call to one call center among said plurality of call centers based on a type of service requested by said caller as determined by said interactive responses received by said IVR module.

12. A method for providing directory assistance, said method comprising the steps of:
receiving a call at an IVR module so as to obtain interactive responses from a caller pertinent to call center routing,
receiving said call at an ICM module, coupled to said IVR module, and routing said call to any one of a plurality of call centers, wherein a call center among said plurality of call centers selected by said ICM module is selected based on said interactive responses received by said IVR module.
